(19) United States
(12) Patent Application Publication
(10) Pub. No.: US 2021/0279766 A1
(43) Pub. Date: Sep. 9, 2021

(54) Computer-Based System and Method for Providing an Augmented Reality Interface at Real-World Music Festivals

(71) Applicant: Peter Garrett, Mill Valley, CA (US)

(72) Inventor: Peter Garrett, Mill Valley, CA (US)

(21) Appl. No.: 17/183,815

(22) Filed: Feb. 24, 2021

Related U.S. Application Data
(60) Provisional application No. 62/985,228, filed on Mar. 4, 2020.

(51) Int. Cl. G06Q 30/02; G06T 11/00; H04L 29/08; G06Q 10/02; G06Q 20/12; G06F 16/2458; G06N 3/04

(52) U.S. Cl. CPC G06Q 30/0252; G06Q 2230/00; H04L 67/1097; G06Q 30/0267; G06Q 10/02; G06Q 30/0246; G06Q 30/0269; G06Q 30/0201; G06Q 30/0205; G06Q 30/0256; G06Q 20/127; G06Q 30/0273; G06F 16/2465; G06N 3/0427; G06T 11/00

(57) ABSTRACT

An advertising network includes a first network server containing real world media of consumers from a live event, a second network server containing sample media, virtual world media, and supporting meta data belonging to vendors, merchants, or service providers, a server interface to the first server distributed to consumer and third party computing appliances and a non-transitory medium resident on the first server containing machine-readable code thereon, the code instructing the first server to (a) process the real world media against sample media to identify virtual objects associated with virtual world media and supporting meta data, (b) upon recognition of a virtual object(s), retrieving associated virtual world media and supporting meta data, (c) integrating the retrieved virtual world media and supporting meta data with the real world media producing an augmented reality overlay layer, and transmitting that to a computing appliance operated by the consumer for display and interaction.

### CROSS-REFERENCE TO RELATED DOCUMENTS

The present invention claims priority to a U.S. provisional patent application Ser. No. 62/985,228, filed on Mar. 4, 2020, entitled “Computer-Based System and Method for Providing an Augmented Reality Interface at Real-World Music Festivals”, disclosure of which is included herein at least by reference.

### BACKGROUND OF THE INVENTION

### 1. Field of the Invention

The invention relates generally to computer methods and systems for processing electronic data related to finance, more specifically, to providing an augmented reality interface at real-world events.

### 2. Discussion of the State of the Art

In the arts of financial management much evolution has occurred toward enabling a typical consumer to achieve basic goals of consumerism and consumer protection such as reducing the number of steps required to complete transactions, making financial data more readily available to the user, allowing the user easy access to price comparison analysis, improving the user's general experience relative to products and services sought by the consumer, improving fraud detection on behalf of users, and so on.

More recently in the art users may store financial related data on third-party platforms that may perform specific services for users who engage in online consumer practices. Such data may be downloaded by the user and written to dynamic transactional cards or devices for use in transacting. Such third-party platforms, generally referred to herein as money pay services may provide transactional management services to users including management of purchases made, receipts accrued, rewards points accrued, tax deductibles, purchase categorizations, spending analysis, purchase history management, and so on.

Relationships between issuers of consumer accounts and these third-party platforms enable aggregation of financial related data of user's accounts registered with those platforms and make it more convenient for users to make purchases and perform tasks with less effort. However, much improvement is needed to further refine consumer goals such as use of earned points, application of discounts, competition in comparing offers, ease of distributing and accepting payments, and other tasks that currently require a user to access more than one platform, service provider, account issuing entity, and user interface.

Likewise, companies who offer online services and products seek to improve and develop new ways to advertise to consumers, retain consumer loyalty, and improve access to more consumers they may add to their client bases. Providers use memberships, loyalty programs, bonus programs, temporary price reductions, discounts for quantity programs, etc. in efforts to compete against other providers for consumer business.

Concurrently, advertisers have developed methods and systems that enable a technology known as augmented reality to provide consumers engaged in recording media or watching previously recorded media an interactive experience associated with the media the consumer is engaged with. For example, a televised program may include an augmented overlay that reveals virtual media that correlates in at least some respects to the original media a consumer is engaged with. The original media displayed on a display device on a computing appliance operated by the consumer may include virtual interactive images, interactive icons, interactive video, or interactive text overlaid and displayed in sync with the original media frame by frame. A consumer may interact with presented links embedded in the virtual data to invoke browser navigation on the consumer's computer appliance to network hosted points of sale (POS) nodes, shopping cart Web pages on secure servers that host transactions between the consumer and third parties.

Third-party entities must create the virtual media elements and associate those in overlay frames that are played or viewed in synchronization with the original media. For example, interactive television uses augmented reality to provide consumers with information and network navigable paths to enable consumers to see the brand and price of an object, for example that is present in the original media. To illustrate an example, consider a modeling catwalk video where interactive tags are overlaid onto specific clothing items worn by the models so a consumer may navigate to a third-party platform from within the augmented reality display on their computing appliances.

In augmented reality, meta data may be associated with objects revealed in real world media comprising a media presentation broadcast live and accessed by a consumer. In other examples of augmented reality, information prepared in advance about real world subjects or scenes filmed or photographed can be associated to recognized objects and may be accessed by clicking, for example, on a virtual outline superimposed over the objects using the overlay technique. Icons, outlines, information balloons, pop up messages, etc. all represent virtual media objects that may be associated to the real-world objects statically or dynamically as soon as the objects are recognized.

For augmented reality to work for recorded media there must be recognition by third-party entities providing augmented reality-based transaction opportunities of the media content being recorded including location of site, generic identities of recorded features or objects, identities of performers, actors, or personnel subject to the recording activities and so on. Merging the data for producing the augmented reality content that is viewed by the potential consumer requires significant processing power at the consumer's computing appliance and high-end sensor capabilities on the computing appliance.

Processing speed limitations of an end-node computing appliance adapted for augmented reality can severely limit the richness of the experience for the consumer. Other limitations involve the navigation process from interaction within an augmented reality transmission or live stream where an interaction invoked by the consumer adds power requirements to the computing appliance in addition to the streaming or playback activity occurring on the device potentially causing a reduction of quality or abandonment of processing for the original media favoring processing for navigating a network and communicating with a third-party interface.

Therefore, what is clearly needed is computer-based system and method for providing an augmented reality interface at real-world events.

### BRIEF SUMMARY OF THE INVENTION

According to an embodiment of the present invention, an advertising network is provided and includes a first server connected to the network, the first server coupled to at least one data repository containing real world media belonging to individual ones of consumers that recorded or are recording the media at a live event, a second server connected to the network, the second server coupled to at least one data repository containing sample media and virtual world media and supporting meta data belonging to individual ones of third party vendors, merchants, or service providers, the sample media previously recorded at the event location, a server interface to the first server distributed over the network to individual ones of computing appliances connected to the network as end nodes, the computing appliances operated by the consumers and third parties, and a non-transitory medium resident on the first server, the non-transitory medium containing machine-readable code thereon, the code executable and instructing the first server to (a) process the real world media captured by the consumer against sample media previously recorded by the third party vendor, merchant, or service provider to identify virtual objects associated with virtual world media and supporting meta data by the vendors, merchants, and service providers, (b) upon recognizing one or more virtual objects designated by the third party vendors, merchants or service providers in the consumer's real world media, retrieving associated virtual world media and supporting meta data, (c) integrating the retrieved virtual world media and supporting meta data with the real world media of the consumer in the form of an augmented reality overlay layer, and (d) transmitting the augmented media to a computing appliance operated by the consumer for display on the consumer's computing appliance.

In one embodiment, the network is the Internet network and any connected sub networks, and the real-world media includes one or more images, videos, or audible recordings. In this embodiment, the virtual world media includes one or more interactive images, icons, videos, pop-up windows, or an audible recording and supporting meta data includes, interactive text, graphics, navigable web links, and executable widgets. In one embodiment, network connectivity between the first server and consumer computing appliances is through one of a third generation (3G), fourth generation (4G), or fifth generation (5G) wireless network, a satellite communication network, a microwave radio network, local area network (LAN), a wireless fidelity (WiFi) network, or a wide area network (WAN). In this embodiment, the computing appliance is one of a lap top computer, a personal digital assistant (PDA), a cellular phone, a smart phone, a smart watch, or another smart wearable device.

In one embodiment, the stored real-world media and the stored virtual world media may be data mined for patterns wherein the pattern data may be incorporated into a rule associated with an executable command that may be automatically triggered or manually triggered. In this embodiment, an action resulting from triggering an executable command may include, initiating a financial transaction, sending a digital message or notification, registering a digital vote, sharing computer displayed content between two or more consumers, sharing pattern data amongst consumers, providing digital access to value offers, making or securing a reservation, providing edit access to pattern data, accessing a website, accessing one or more digital files including media content, invoking a navigation path in a web browser extension or a meta browser extension and sharing Geo-location data of a consumer with one or more other consumers or third parties.

In one embodiment, the advertising network of claim 1 further includes a function (e) for a processor augmenting real world media with virtual world media and supporting meta data to access a neural platform and retrieve one or more consumer preferences relating to stored real-world media and associated virtual world media and any supporting meta data. In this embodiment, the one or more consumer preferences are discovered from pattern data recognized on the neural network. Also, in this embodiment, the pattern data includes one or more of data search patterns of a consumer, advertisement response patterns of a consumer, purchasing patterns of a consumer, account selection patterns of a consumer, value or offer redemption patterns of a consumer, and geographic location patterns of a consumer.

In a variation of the embodiment wherein a command executes a browser or meta browser extension, the web browser extension or the meta browser extension is a computer program using an application programming interface from the first database to integrate with existing web browsers including but not limited to Google Chrome, Opera, Microsoft Explorer, Apple Safari, and Mozilla Firefox. In one embodiment, virtual objects are recorded by third party vendors, merchants or service providers and are associated with virtual world media and associated meta data.

In one embodiment, consumers and third-party vendors, merchants, and service providers subscribe to a service to enable practice on the advertisement network. In this embodiment, the third-party vendors, merchants, and service providers pay for virtual objects as advertising space. In one embodiment, the first and second servers share a media storage platform repository for storing real world media and virtual world media and supporting meta data instead of maintaining separate media repositories.

### BRIEF DESCRIPTION OF THE SEVERAL VIEWS OF THE DRAWINGS

FIG. 1 is a block diagram representing a live event attended by consumers adapted to receive virtual media through augmented reality interfaces on their computing appliances.

FIG. 2 is an architectural overview of a first data platform for presenting augmented reality meta data and for handling transactions resulting from consumer interaction with virtual media.

FIG. 3 is a block diagram of the media storage platform of FIG. 2 depicting rules-based commands that may be triggered to execute by the presence of or interaction with consumer pattern data.

FIG. 4 is a process flow chart depicting steps for generating augmented reality content for a consumer according to one aspect of the present invention.

FIG. 5 is an architectural overview of network connectivity and endpoint options for receiving augmented reality content from the network in near real time.

FIG. 6A through FIG. 6C depict a third-party platform web page with a consumer browser (or meta-browser) extension invoked for transacting between the third-party and the first data platform.

FIG. 7 is a screen shot of the live event of FIG. 1 displayed as an augmented reality content on a consumer's appliance.

FIG. 8 is a block diagram depicting general processing, analytical components, and process categories in the first database SW.

FIG. 9 is a block diagram depicting processing on a neural subsection platform.

FIG. 10 is a process flow chart depicting steps for training the AI model of FIG. 9.

FIG. 11 is a block diagram depicting intelligent processing of instant transactions using the AI model 600 of FIG. 9.

### DETAILED DESCRIPTION OF THE INVENTION

In various embodiments described in enabling detail herein, the inventor provides a unique system for supplementing real world media with interactive virtual media and presenting that to consumers at a real-world event. A goal of the present invention is to present interactive links to meta data into media that has just been captured by largely wireless consumer computing appliances, the meta data providing both useful information about the event and vendors at the event and third-party web links for transactional purposes. The present invention is described using the following examples, which may describe more than one relevant embodiment falling within the scope of the invention.

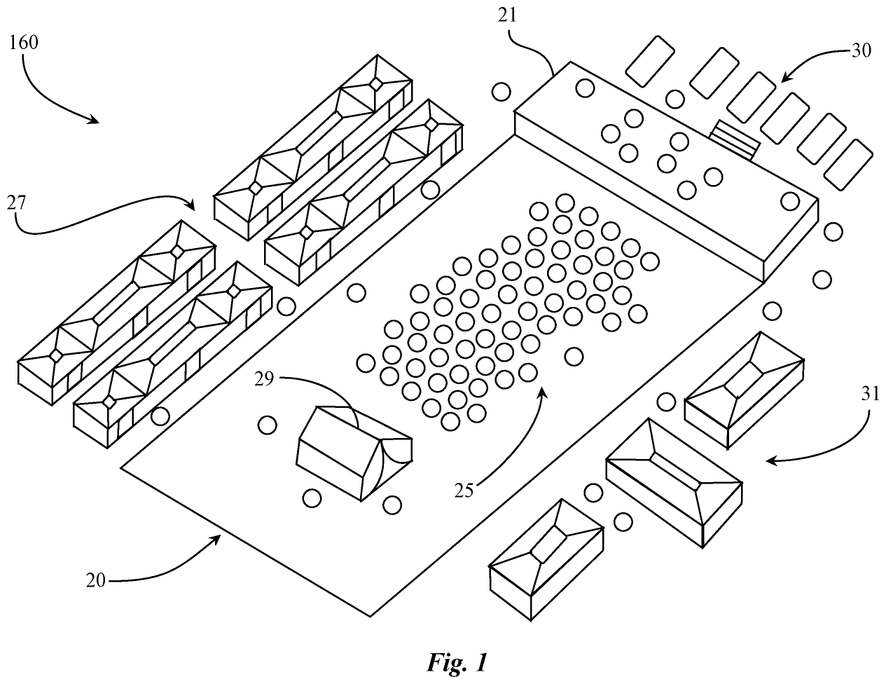

FIG. 1 is a block diagram representing a live event, referred to herein as a real-world event 160 attended by consumers referenced herein as consumers 25. Individual ones or all of consumers 25 may be adapted to receive virtual media through augmented reality interfaces on their computing appliances they carry with them. In this exemplary embodiment, real world event 160 is a music concert or festival put on by third-party entities such as music promoters wherein in one or many live bands will perform on stage 21. The present invention lies within the domain of a network-based system that aids in the production of augmented reality at real world music festivals such as at real world event 160 as well as many other types of real-world scenarios whereby media captured by consumers 25 is recognized, identified, and matched with virtual media that is previously stored by one or more third-party entities the virtual media associated with samples of real-world media and other pattern data. The virtual media is retrieved by the system and synchronized with the captured real-world media as interactive virtual overlay to the real-world media captured.

In a preferred embodiment, consumers 25 may previously subscribe to and install the capability on their wireless computing appliances such as an I-phone, smart phone, video camera, or other appliances capable of connecting to and browsing a computer network and recording of images, video, and audio while attending a real-world event. Although not depicted in this overhead view, each consumer 25 or individual ones of consumers 25 is enabled through their computing appliances to practice the invention may receive the real-world media, albeit with a slight network latency on the displays of their appliances. For example, real world media may include one or more images or one or more video/audio clips, or one or more audio recordings a consumer 25 captures at the real-world event 160. Virtual world media is created in part based on real world objects known to the third parties and may be sponsored by promoters, vendors, advertisers, medical professionals, information providers, event or activity organizers, band members, and other consumers 25 (functioning as third parties).

It is noted herein that third-party entities, like consumers are adapted to practice the invention through subscription to a service that provides access to subscribed consumers attending events they are sponsoring or otherwise “working”. For example, a tent 29 may house music PA equipment and operators as well as a medical station and a place to meet up or advertise that one person has lost contact with another or the like. Third parties associated with tent 29 may include the likes of music sound producers and promoters, medical services providers like hydration services, paramedic services, etc. These third parties may capture and store sample media and meta data with the service and may create interactive virtual media or static informative media and store that in association with images and data known about that with location 29 (central tent). The sample media may also include previously captured images of surrounding features fixed in the layout of the event grounds like stage 21, a group of concession and retail providers or vendors 27, a group 31 of buildings of interest to consumers (rest rooms, museum, gift shop, etc.) on the other side of a central event area 20 from vendors 27. Group 31 may be referred to collectively as vendors 31.

The network-based system uses a data platform and wireless network connectivity to connect consumer appliances to a first data platform that may produce the augmented reality for individual consumers connected thereto and to manage any transactional activities whether automatically triggered by a consumer or whether manually pursued by the consumer. In interaction with augmented media, the consumer 25 may select, click on or hover over a virtual world icon or other interactive indicia to make a purchase, locate another user and or obtain information about real world objects. A real-world object is anything that is a feature of or associated to a feature of real-world location (stage, building, lot, tent, etc.) that may be subject to media capture by a consumer 25. A parking area 30 is depicted herein behind stage 21.

Each consumer 25 has at any given time, a location, and a camera vantage point for capturing media. For example, if a consumer were seated high above the real-world event, then image 160 including all of the visible features thereof might be captured in a media capture event executed by the consumer while connected to the service. For example, any consumer 25 taking a recorded image or video clip of musicians on stage 21 may submit that for recognition and overlay with associated virtual media including but not limited to the name of the band on the stage at the time of recording, the band set list of songs, meta data describing the band and band members, and a link to the band's transactional website for purchasing music CDs and other band merchandise. In this case, stage 21 is the virtual world object, and the timing of the recording may dictate which band's virtual world media is overlaid over the image or video clip.

A consumer taking an image or video of one or more tents 27 may receive virtual world media in display including but not limited to food vender name and tent location, a link to a digital menu for ordering, and advertisements of discounts based on proximity of the consumer to the vendor tent. If the consumer media includes all of the tents, then multiple virtual world objects may be represented. If only one tent is framed in the real-world media, then one virtual object may be identified, and the virtual world media might be limited to that provided by or sponsored by the third-party vendor.

If a consumer 25 records media of one or more buildings or tents 31, the system may recognize them by matching with previously recorded sample media and may retrieve the appropriate virtual world media to overlay over the real-world media for the subsequent augmented media presented to that consumer. The consumer may have access to but not limited to merchandise names and pricing, links to third-party web sites, information about each third-party vendor or sponsor, open and close times, and so on.

If a consumer 25 happens to photograph or film the parking area 30 behind stage 21, the consumer may receive information including but not limited to location of the consumers parked car, exit time where cars may be allowed to start leaving, best traffic routes to take away from the area, congestion or traffic jam states in the parking area including estimation of clearing time, etc. Time stamps of recorded real-world events may play a role in which virtual media is selected for augmenting the consumer's captured media.

In one embodiment, one consumer 25 may track one or more other consumers by current GPS location by capturing an image or video of a virtual world object that may be associated with the other consumers as a place to meet up at a certain time. In this variant application, a consumer may associate a reminder for everyone to meet at a certain time and place during an event if they plan to split up or meet one another at the event. The consumer may create and upload a virtual world object and or associate virtual world data to one or more virtual world objects that defines the meet up place and time and who should meet there at that time. The system may send messages to the involved consumers and the sponsoring consumer like a reminder when any one of those consumers takes an image or video of the virtual world object.

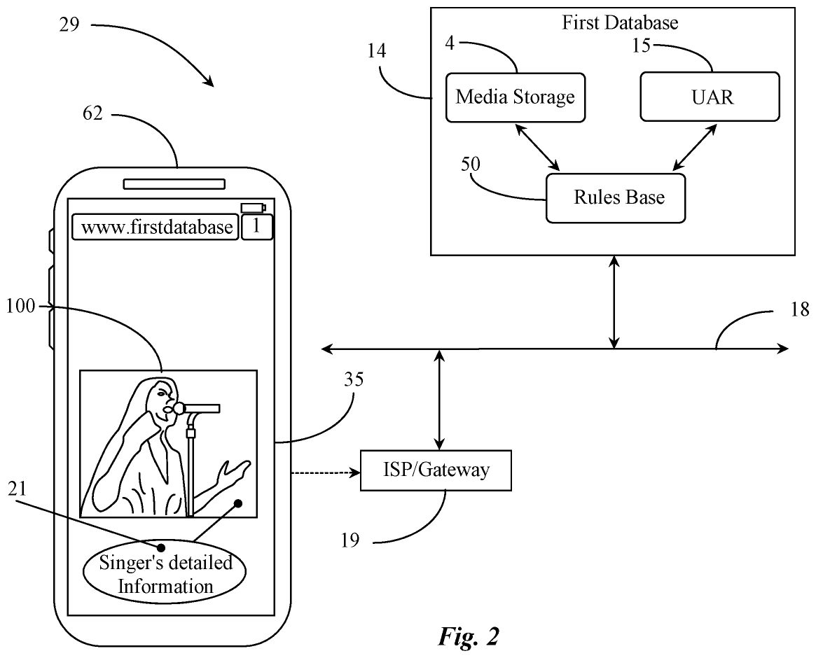

FIG. 2 is an architectural overview 29 of a first data platform for presenting augmented reality meta data and for handling transactions resulting from consumer interaction with virtual media. In FIG. 1 it is described that consumers are adapted to practice the present invention on their computing appliances they have with them at a real-world event. In this example, a consumer uses a computing appliance 62 in the form of a smart phone. Smart phone 62 is connected to a network backbone 18 by way of an Internet service provider (ISP) gateway 19. Network 18 may be an Internet network or other type of wide area network (WAN) public or private without departing from the spirit and scope of the present invention.

A display such as display 35 may include, for example, a liquid crystal display (LCD), a light-emitting diode (LED) display, an organic LED (OLED) display, an active-matrix OLED (AMOLED) display, a plastic OLED (POLED), a microelectronic systems (MEMS) display, or an electronic paper display. The Display 35 may display, for example, various types of content including text, an image, a video, an icon, and/or a symbol for the consumer. The Display 35 may include a touch screen and may receive touch, gesture, proximity, or hovering input using, for example, an electronic pen or a body part of a user.

Computing appliance 62 may be and typically is a mobile computing device however that is not required in order to practice the invention. Computing appliance 62 may be a laptop or notebook computing appliance, a tablet computing appliance, a mobile smart phone, a smart watch with media recording capability and a display, a smart wrist band, a smart ring, or a pair of smart eyeglasses. The sole requirements of the computing appliance used is that it has a display and SW for playback of recorded media, a camera and microphone for capturing media, a modem or chip for connecting to a wireless carrier network, a processor for processing and displaying augmented reality content, and a network browser for navigating network 18.

One skilled in the art will appreciate that a Network 18 may include any system for exchanging data or transacting business, such as the Internet, an intranet, an extranet, WAN, LAN, satellite, or wireless communications, and/or the like. Moreover, although the invention and its platforms use protocols such as TCP/IP to facilitate network communications, it will be readily understood that the invention could also be implemented using IPX, Appletalk, IP-6, NetBIOS, OSI or any number of existing or future protocols. Moreover, the method and the system contemplate the use, sale, exchange, transfer, or any other distribution of any goods, services or information over any network having similar functionality described herein.

A first data platform 14, referred to also as a first database is supported by network backbone 18 and is in the domain of the service provider of the service of this invention. Among other tasks and capabilities, first database 14 may register money accounts for a consumer wherein one or more accounts held by the consumer are registered in database 14 in a user account registry (UAR) 15. A consumer account may include but is not limited to a MasterCard®, Visa®, American Express®, Discover® Financial Services, FDC® (First Data Corporation), TSYS®, or Certegy® account financial data that may be kept with account data may include a driver's license number, a passport number, a debit account, a credit account, a checking account, a money-market account, a stored-value account comprising previously paid financials, or the like. Optionally, a stored value account with a participating financial account issuer (i.e., a bank or a rewards provider, etc.) may be previously credited with funds, or financial, from the financial account issuer and for the use of which the User has previously-paid a premium to the financial account issuer. All such data mentioned above may be registered for the consumer.

First database 14 may include a significant amount of memory for media storage as depicted by a media storage repository 4. Media storage repository 4 or media storage 4 may include real world media content along with virtual world media meta data which may be used to overlay the real-world media to produce augmented media content (augmented reality). Real world media along with virtual world meta data may be received at the First Database 14 having been uploaded thereto from a consumer's computing appliance 62 or from a third-party platform. For example, details about the music festival 160 may be provided to the first database 14 by the music festival promoters, the vendors, and the music acts. Such information may include the roster of musical acts performing at the music festival, the merchandise available for purchase at the music festival, ticketing options for various zones and/or times within the music festival, location of bathroom facilities, etc.

First database 14 also includes a rules base 50 containing rules and executable commands enabling the system to process transactions on behalf of a consumer based on interaction by the user with the virtual media or meta data received by the consumer in an augmented reality media content displayed on their computing appliance 62. In this simple exemplary embodiment, the consumer has recorded an image or video of a band member on stage at the event associated with a virtual world object 100 or made a virtual world object 100. Virtual meta data 21 is overlaid on the image or clip giving the consumer the singer's name and other detailed information. The link may be embedded in the overlay and the consumer may hover over it or select it to see the related meta data and or links to cause browser navigation to a third-party site.

SW installed on the consumer's computing appliance 62 may include a thin client application in the form of a browser extension or a meta browser and sub-extensions for enabling system use of the camera and video functions, certain processing functions, and any augmented reality display routines on the computing appliance. In one embodiment, augmented reality may be produced in first database 14 and sent to the consumer's appliance. In another embodiment, the augmented reality may be created from separate data streams received at the computing appliance.

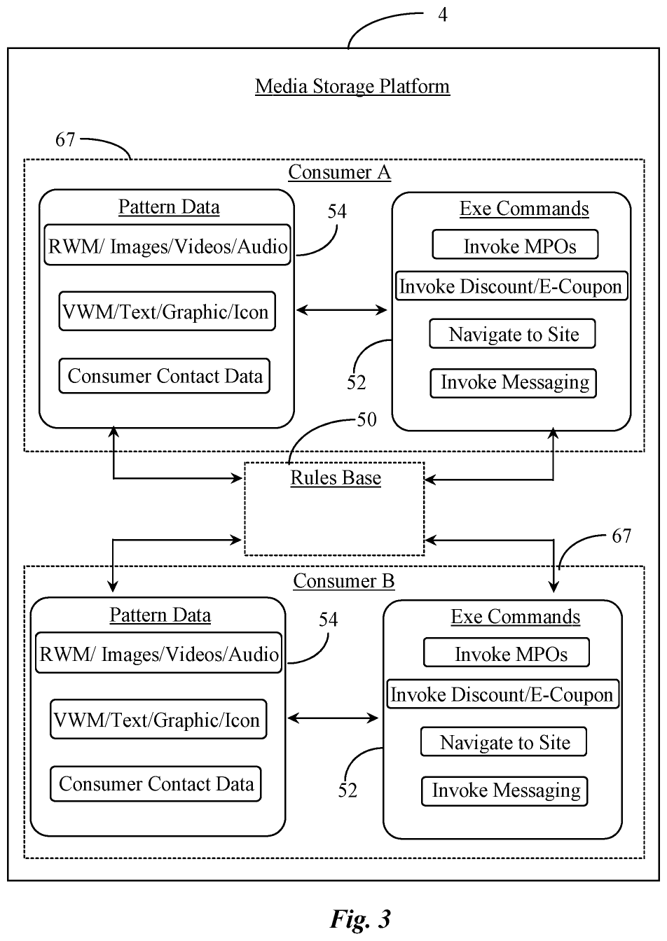

FIG. 3 is a block diagram of the media storage platform 4 of FIG. 2 depicting rules-based commands that may be triggered to execute by the presence of or interaction with consumer pattern data. Media storage platform 4 may be a shared resource wherein a registered space is available to individual ones of many consumers. Registered financial data 67 may be secured for each consumer and protected from unauthorized access through the UAR registry described further above. Therefore, a financial data platform 67 containing consumer accounts 65 and related data may also be a shared resource segregated securely for multiple consumers.

Financial platform data for a consumer A may include pattern data 54 associated with rules-based execution commands 52. Pattern data 54 may include among other data, data for performing augmented reality overlays. Such data may include real world media uploaded to media storage repository 4 by consumer A. Pattern data 54 for consumer A may include virtual world media expressed as text graphics or icons. Pattern data 54 for consumer A may also include consumer contact data. Executable commands based on rules in rules base 50 are depicted herein as commands 52 and may be associated with pattern data 54 for consumer A. Execution commands 52 may include but are not limited to commands for invoking merchandise purchasing options, commands for invoking merchant discounts or use of E coupons, command for following a link in navigation to a third-party platform, and commands to invoke messaging applications on the consumer's computing appliance.

As depicted in this example, consumer B has the same general attributes on the data platform as consumer A and shares rules base 50 as a resource. Command data 52 may include commands associated with financial accounts (65) of a consumer. Certain commands 52 may be triggered to execute base of which virtual media is interacted with by a consumer displaying augmented media. Therefore, pattern data 54 may also include financial account data. Rules base 50 may be secured in part to a single consumer and rules created by the consumer and rules provided as generic rules by the system may be accessible to the consumer's registered platform or the first data base.

In one embodiment, consumers have a thin client SW application that they may leverage to set up and manage their individual data platform services. Third parties may have authorized access to consumer data by request and authority by consumers. Third party data including virtual world data and meta data may be sent to consumers who have captured real world media that can be identified by system and or third-party platforms. Processing may be distributed across the consumer platform and third-party platform or between the consumer platform and the consumer's computing appliance without departing from the spirit and scope of the present invention. For example, transacting may occur in the first database wherein a transaction or transactions are previously authorized by the consumer and triggered by the consumer capturing and submitting real world media to be identified and augmented for consumer interaction.

In one embodiment a consumer may be directing the activity by interacting with the virtual world icons or meta data to invoke commands that cause navigation to a third-party platform where the consumer may shop or browse information and engage in transactions using the thin client application browser extension that provides a direct interface without redirecting the consumer to another site via a pop-up secure transaction window made a part of the browser or meta browser.

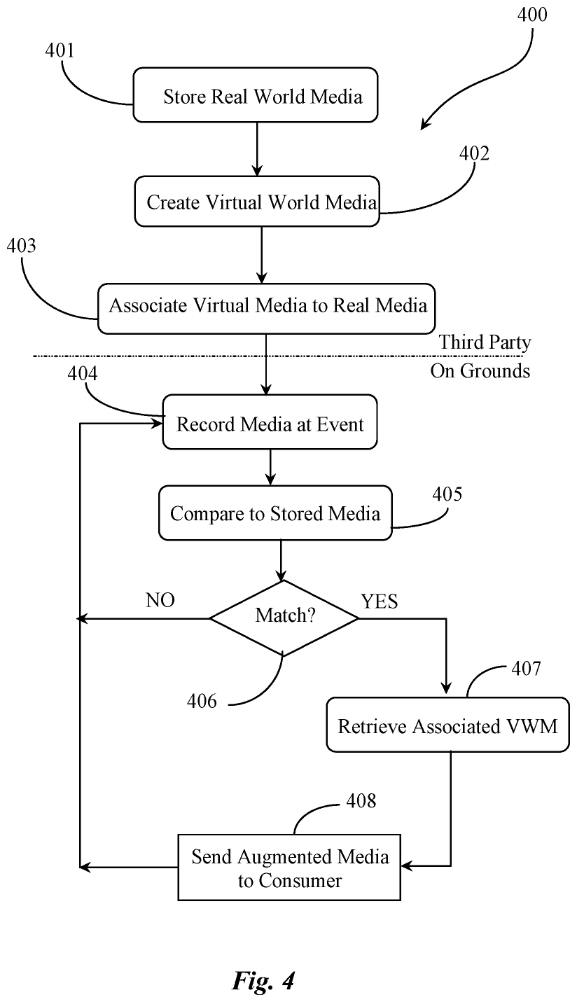

FIG. 4 is a process flow chart 400 depicting steps for generating augmented reality content for a consumer according to one aspect of the present invention. At step 401, a third party may record and store some real-world media. For example, if the third party is a vendor, they may record images and or video/audio of the venue generally as referred to in FIG. 1 like stage 21, tent 29, and vendors locations 27 depicted in FIG. 1 above. The vendor may create virtual world media and virtual world meta data at step 402 to direct consumers to the merchant location of the vendor at the event and provide access to the vendor network or digital domain through embedded links in the meta data or virtual world media. The virtual world media may be stored in media storage platform 4 for the subscribing vendor wherein the virtual meta data and media created is associated by design at step 403 to the real-world media stored.

At step 404, a consumer attending the event where the vendor is working may capture real world media while in attendance of the live real-world event, the event described as a music festival in this exemplary embodiment. At step 404, the captured media may be streamed live to the consumer's first data platform (database 14) as it is being recorded while the consumer has wireless connection to the data platform and the application or browser extension working in the background on the consumer's computing appliance (62). In one embodiment, the consumer may record the media then upload it to the data platform sometime after it was recorded and saved on the consumer's appliance.

At step 405, the first database platform makes a comparison of the media captured by the consumer and media stored by one or more third parties having stored real world media identified as sample media associated with real world objects and associated virtual world media and virtual world meta data. The system may have access to the consumer's real-world media and to one or more third party media stores associated with that live event.

At step 406, the system may determine if the real media uploaded by the consumer matches with real world media uploaded to the platform by one or more third parties working the event. If at step 406, the real-world media recorded by the consumer does not match any of the third-party media, then the process may resolve back to step 404 looking for more real-world media from the consumer. If at step 406, the system matches real world media between the consumer and one or more third parties, then at step 407, the system may retrieve the associated third-party virtual world media and using augmented reality processing, create an augmented reality media content for transmission to the consumer to be displayed for the consumer to interact with. The process may loop back to step 404 until the consumer stops using the camera and submitting media to the platform.

It is noted herein that media may be identified while it is being recorded, for example, a video, wherein the virtual media may be streamed to the consumer's device whereby an augmented reality processor performs the augmentation of the virtual world media to the real-world media being captured buffering the data before it is displayed. In another embodiment the augmentation may be performed on the first data platform (14) and streamed to the consumer for display, replacing the real world viewing with augmented reality containing the interactive media.

One with skill in the art of networking will appreciate that a third-party platform may interact with a consumer platform in a secure manner for the benefit of the consumer and may be subject to verification regimens and registration requirements before being granted access to any consumer data. Likewise, first data platform 14 may be distributed using network servers to reduce latency between the third-party platforms and consumer's computing appliances. There are no Geophysical limits to practicing the present invention.

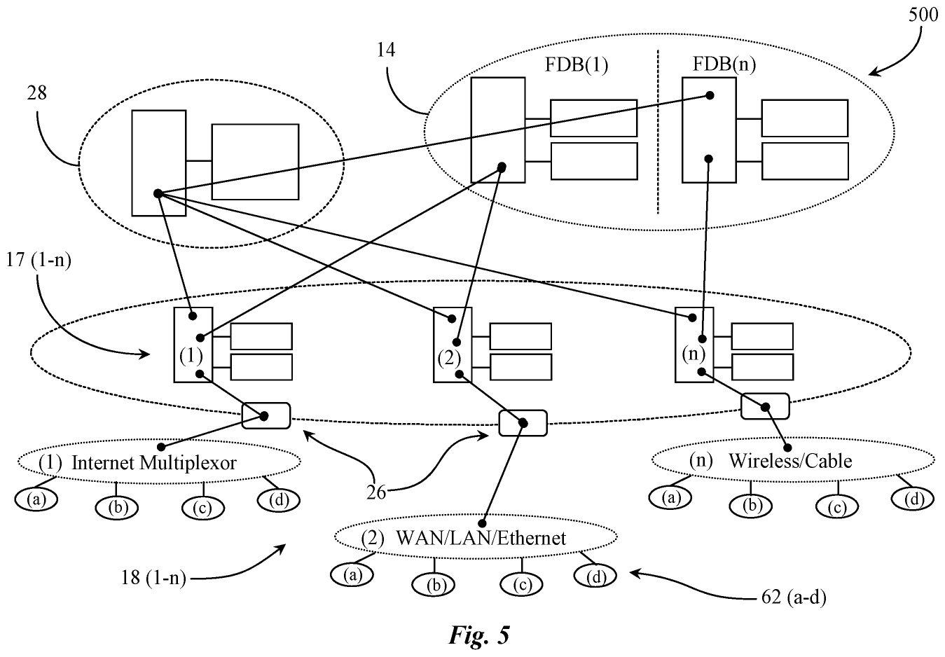

FIG. 5 is an architectural overview of network connectivity and endpoint options for receiving augmented reality content from the network in near real time. Referring now to FIG. 5, a distributed system architecture 500 is depicted for processing financial transactions by way of subset data platforms 17 under the master data platform 14, the subset databases being distributed remotely over the Internet 18. Architecture 500 supports payment processors at TP platforms 28 to control returning authorization messages to a merchant accessing the TP platforms 28 through gateways to payment networks like Visa™, MasterCard™, Discover™, Interlink™ and American Express™) and or the TP platforms 28 defined as consumer account issuing institutions.

Distribution in this embodiment includes hardware and SW and processing capability. Distributed processing allows for a reduction in latency in transacting over the network making it possible for goals to be realized in some aspects in real time while a consumer is recording media at the event and interacting with augmented reality to gain information, to locate services, or to conduct transactions for merchandise or concession items.

In one embodiment, an execution command 52 optionally requires the first data platform including the master first database 14 and a processor to communicate with at least one external or third-party computer or platform to conduct a consumer's financial transaction. In one embodiment, a consumer may attend an event, save images and video shot at the event, and then later after the event, submit the media content to the service for processing to receive the augmented reality playback of the media on any computing appliance of the consumer. Therefore, consumer appliances 62 (1-d) may access subset data platforms 17 (1-n) through networks 18 (1-n) (local access/carrier) via gateway platforms (GP) 26 (1-n). In one aspect access may be achieved via an Internet multiplexor network 18 (1), or a LAN/WAN network 18 (2), or through a wireless carrier network or cable network 18 (n).

It is noted herein that communications between the data platform 14, subset platforms 17, consumer appliances 62, and third-party platforms 28 may be accomplished through any suitable network 18 like a telephone network, intranet network, Internet network, etc. Consumer points of interaction may include POS terminals, network connected appliances (62) or devices including, personal digital assistant (PDA), cellular or smart phone, kiosk, smart watch, or another smart wearable. Interaction may include online embodiments, offline embodiments, wireless embodiments, etc.

The advertising network may maintain network connectivity between the first server and consumer computing appliances through one a third generation (3G), fourth generation (4G), or fifth generation (5G) wireless network, a satellite communication network, a microwave radio network, local area network (LAN), a wireless fidelity (WiFi) network, or a wide area network (WAN).

One skilled in the art will appreciate that any databases, platforms, or domains of the present invention may consist of any or a combination of databases, and other mentioned components located singularly with respect to location or distributed (preferred embodiment) at a plurality of locations. Suitable transaction security may include any of various suitable security features and protocols, such as firewalls, access codes, tokens, encryption, decryption, compression, decompression, etc. In a preferred embodiment, consumers are encouraged to live stream media to the first database for processing, which may occur at a mirror site or subset database 17. In this way the process described above with respect to FIG. 4 flow chart 500 may be conducted in near real time with only a minute buffering delay for overlaying the virtual world media and meta data.

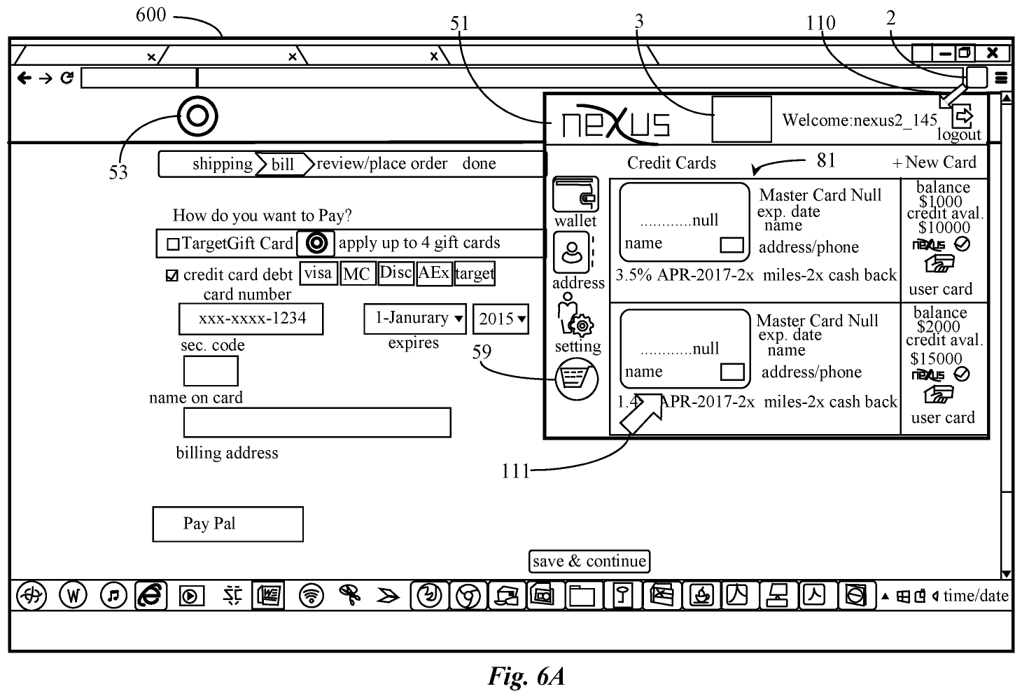

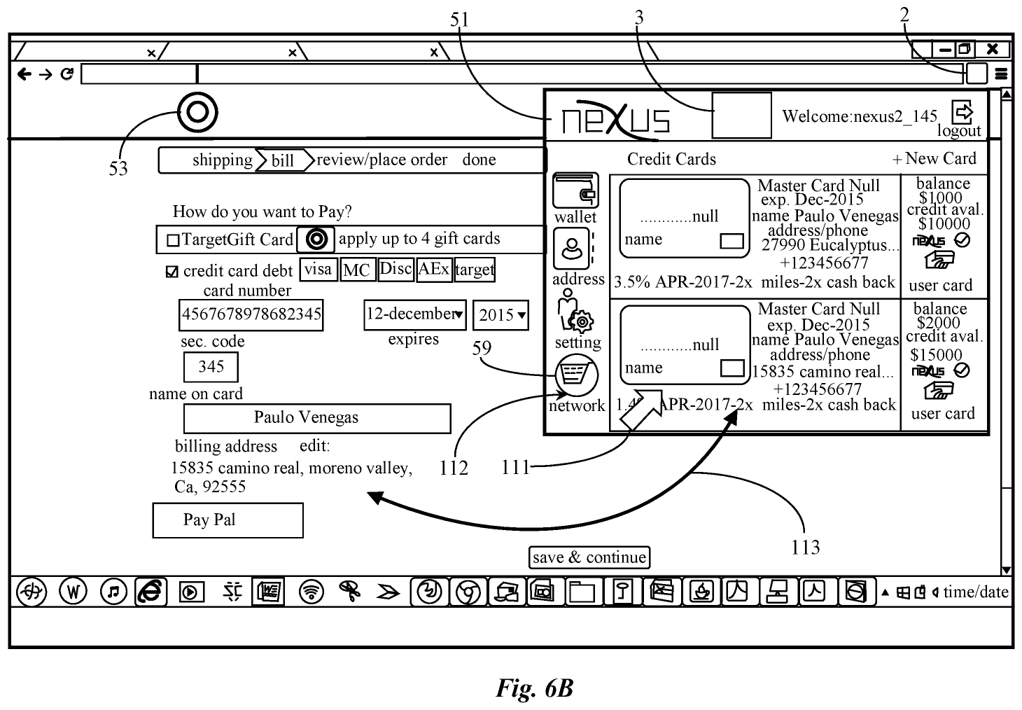

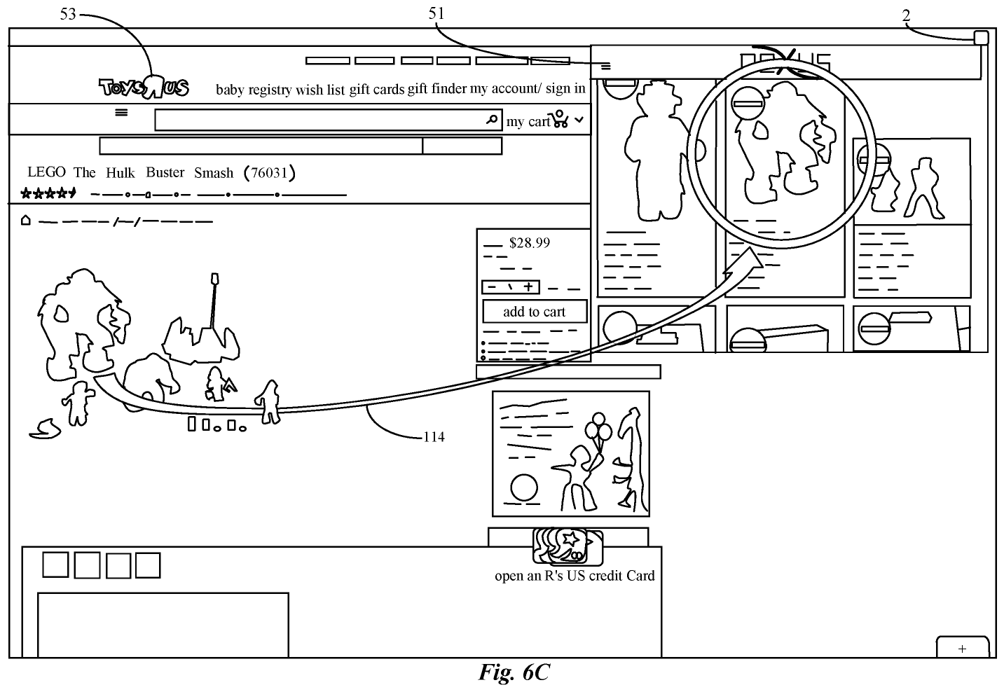

FIG. 6A through FIG. 6C depict a third-party platform web page with a consumer browser (or meta-browser) extension invoked for transacting between the third-party and the first data platform. A pop-up window 51 may be invoked according to consumer interaction with virtual world data or meta data which transmits secure socket layer data from the first database via HTTPS or S-HTTP to the user's browser. Referring now to FIG. 6A, a screen shot depicting a third-party Web site 53 (Target) includes access to a browser extension 2 invoked to access the first database or first data platform (14) or a subset thereof via a meta browser interactive pop-up window 51. Extension 2 is invoked, which invokes an act 110 that brings up for display the meta browser window 51 displaying a menu of a plurality of visible account signatures 81 in the form of an icon or text representing a consumer financial account 65 registered in the first data platform 14 for presentation to the consumer in the displayed window 51. The consumer may select one of the displayed account signatures to designate that account from accounts 65 for invocation by the first data platform 14 as the account that would be used to complete a transaction.

The menu (window 51) may include current interest rates, available credit lines, expiration dates, and current balances. Window 51 may also include one or more advertisements 3 personalized to the consumer based on data mining and analysis of the consumer's data resulting perhaps from tracking the consumer's browsing and purchase patterns across a plurality of the consumer's browser-based computing appliances (62). Window 51 may pop-up for the purpose of transmitting secure socket layer data from the first database 14 via HTTPS or S-HTTP to the consumer's browser. Other consumer profiling methods may also be used in combination with or separate from tracking browsing activity. Rule modules or simply rules (50) are adapted among other things to invoke preferences, tagging, and rankings 111 of consumer accounts including designated default consumer accounts and a private code, which the user may select at registration and which may be presented by the first data platform to the consumer on the consumer's personal appliance to confirm that the user is accessing the authentic database 14 and any authentic third party platform registered with or recognized by the first data platform.

Referring now to FIG. 6B depicting a screen shot of the third-party Web page of FIG. 6A highlighting a secure transfer of data from a first data platform (14) (first database) to the end device browser application of the consumer. FIG. 6B is a screen shot of the third-party Web page of FIG. 6A depicting secure transfer of data. An act performed by the consumer with pop-up window 51 open, referred to herein as act 112 invokes a discount network 59 from within the pop-up window 51, such that clicking on the discount network 59 icon invokes coupon-codes which are auto-filled into the checkout boxes of the Web page 53 to reduce the cost of the consumer's selected product or service. In this instance, the first data platform 14 may connect by way of network (18) to a third-party platform (28) that is adapted to provide a service for aggregating electronic coupon codes. In an act 113, an auto-fill function is invoked to auto fill one or more checkout data entry boxes on the Web page 53. This may be accomplished without requiring an application program interface (API) the third-party Web page in the consumer's browser, or a form navigation re-direct away from Web page 53. E coupons, discount codes, etc. may be incorporated by third party vendors working the event the consumer is attending or has attended.

Referring now to FIG. 6C depicting a different third-party Web page adapted to practice the present invention. This screen shot highlights a secure data transfer of data from the end device or appliance of a connected consumer to the first data platform (first database). A consumer may invoke discount network icon 59 in pop-up window 51. This action enables the consumer to simply hover with mouse or other selection device to hover over any data presented on web page 53 to automatically invoke and display images and other information about a product or service offered at competitive or discounted pricing from other Web sites through meta browser window 51. In this way, a consumer may easily ascertain whether they are getting the best value for the same product prior to committing to a purchase.

It may be noted herein that a web browser extension or a web meta browser includes a computing program from the first data platform (14) that extends the functionality of a web browser in some distinct way. Depending on the browser and the version, the term may be distinct from similar terms such as plug-in or add-on. Some extensions are authored using web technologies such as HTML, JavaScript, and CSS. Browser extensions can change the user interface without directly affecting viewable content of a web page. For example, a “widget” is a click-able graphical user interface object that may be added. One with skill in the art will appreciate that each browser type has its own architecture and APIs to build an extension which may require different code and defined tasks for each extension.

Development frameworks such as Extension Maker or Crossrider may be used to build cross-browser extensions with only one code base and one API. This limits or obfuscates the need to develop a different extension version for each of the popular browsers like Internet Explorer, Firefox, Chrome, Safari, and Opera.

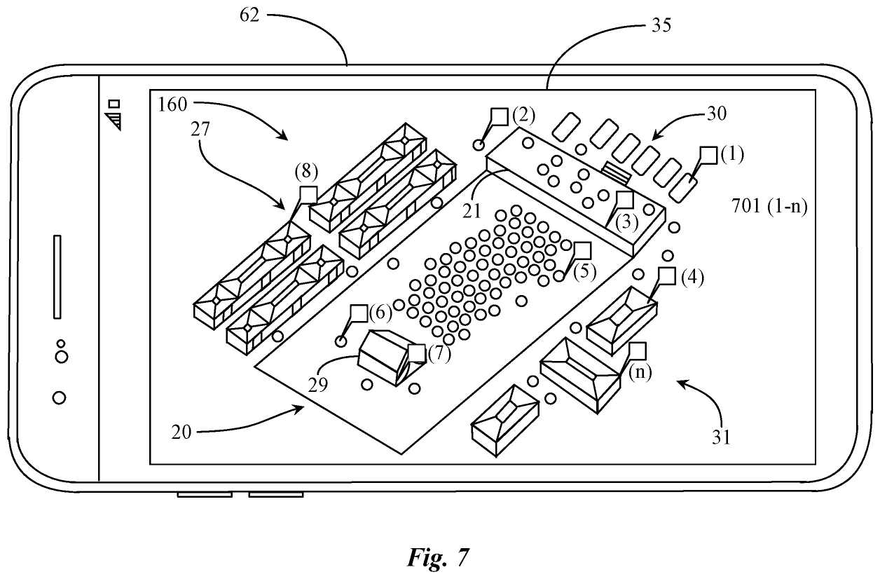

FIG. 7 is a screen shot of the live event 160 of FIG. 1 displayed as an augmented reality display on a consumer's appliance. If live event 160 was captured, for example, with a video camera from the vantage point of being above the event as depicted in FIG. 1, then virtual world media and meta data may be visible in the augmented display. Media captured by the consumer is time stamped. The virtual world media and meta data selected by the system to augment the captured real-world media may vary accordingly. For example, stage 21 may be a virtual world object that when captured in video by a consumer is matched to the virtual world media such as a band, that would according to the schedule, be on the stage at the time the stage video was recognized by the system as a virtual world object of one or more third parties working the event.

In this view, virtual world meta data is displayed herein as dialogue boxes 701 (1-n). Each virtual box is interactive to see more data or to navigate to a third-party web site, or to reveal location or directions, etc. For example, interactive dialogue box 701 (1) may reveal the location of a consumer's car parked in lot 31 behind stage 21. Interacting with the box may cause more data to display such as a map of the event area, current space occupation level in the lot, traffic conditions associated with cars leaving, etc.

Box 701 (2) may reveal the current location of another user, perhaps in attendance with the tracking consumer. Box 701 (3) may reveal band information such as lead singer about information, an embedded link to a band music and merchandise page, or a location of a merchandising tent maintained by the band on site. Discount information for consumers who purchase live at the event as opposed to online may be part of the virtual world meta data that may be garnered through interaction with the augmented graphics, text, icons, moving images, etc. Box 701 (4) may be the event gift shop vendor and Geo-location. Box 701 (5) may be the identification of and real-time Geo-location of a mobile vendor that works the crowed at the event. Box 701 (6) may be a security person or a medic or another professional advertising digitally to consumers who might need some assistance.

Box 701 (7) may be an agreed-to event meet up spot for multiple consumers 25 who have split up during the event. The name of the tent, description, and directions, and time to be there might be made available through interacting with the meta data in augmented display. It is noted herein that messaging applications may also be activated to ensure that connected individuals may receive notifications from one another providing information to all of them. Box 701 (8) may reveal the name and tent location of a food vendor 27 and may include a menu, a way to per-order before arriving to pick up, a current estimation of time to wait before served, etc. Box 701 (n) may be a ticket office vendor selling tickets to the current event or later scheduled events at the same venue.

One result of the type of advertisement through augmented reality media is that broader views may reveal more third-party sponsored virtual objects whereas a narrow view focuses down on fewer virtual objects recognized. However, a vendor working a food tent may have the stage 21 as a virtual object that when recognized causes the vendors data to be augmented into the real-world media. In one embodiment, vendors may pay the service for advertising space, perhaps a small percentage of sales during an event.

In general, virtual world media may include a roster of songs a band will be playing at the event 160, the prices and physical locations for purchasing products for fans of the band such as t-shirts, mugs, and CDs (compact disks). Virtual world meta data may include availability data, costs data, and proximal locations for receiving discounts, purchasing tickets to other parts and performances of the music festival, listing phone number (s) for contacting band management or booking agent, an address for the next live performance, a uniform resource locator (URL) for ordering tickets to a next performance or festival appearance.

Data may also include the distance a virtual object is from a user capturing it on camera, and the like. Execution Commands may be invoked when a consumer touches or clicks on any of the visually displayed virtual world meta data included in the augmented reality display overlaying the real-world media being played. For example, a picture of the band may be overlying the stage (virtual object) with a textual menu of song titles the user can select from, in order to provide a real-time vote for which song the band should play next at the music festival. Further, the user can touch or click on one of the song titles to purchase the track either as a CD or a down loadable file from a streaming service. In this example, any or all of the virtual world media may be actionable via a consumer's audible command (if set up) or the consumer touching or clicking on or hovering over the displayed virtual world media or meta data thereby invoking a command stored on either the first or subset databases. It should be noted that subset database 17 may reside on a server accessible to a plurality of consumer appliances, or it may reside on the consumer's appliance.

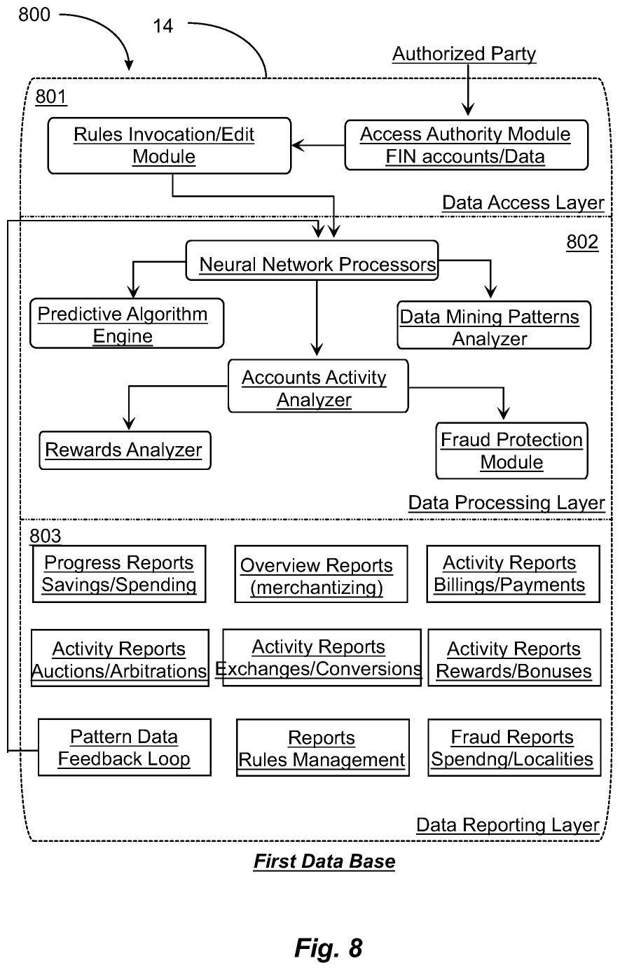

FIG. 8 is a block diagram depicting general processing, analytical components, and process categories in the first database SW. Diagram 800 depicts layers of SW functionality segregated into a data access layer 801, a data processing layer 802, and a data reporting layer 803. Access functions may include but are not limited to querying, editing, and transacting with the financial relative data of the consumer as a result of consumer interaction with the system through augmented reality.

In one embodiment, an authorized party, user, or consumer, may gain access to financial data through an access authority module wherein a query may be accompanied by invoking a rules module (50) that may result in among other things, a presentation of advertisements or rewards incentives to the consumer while the consumer is querying their financial accounts (65). Invocation of any rule through rule module in data access layer 801 may trigger neural network processor functions in processing layer 802. Various processors may launch pan-portfolio analysis, wherein a consumer may access their user account registry and invoke rules by performing a key-word search. Returns may include processed data such as reports including report on any activity in their financial accounts, report on spending by category of expenditures, a report on the chronology of expenditures, a report on items that may be tax deductible expenditures, etc.

Processing layer 802 may include dedicated processors for predictive analysis (predictive algorithm engine), data mining (patterns analyzer), activity detection (accounts activity analyzer), rewards calculation (rewards analyzer) and fraud protection (fraud protection module). Data reporting layer 803 may include results of the various processes occurring in the data process layer 802 including but not limited to progress reports on savings and spending, overview reports (merchandising), activity reports on billings and savings, activity reports (auctions and arbitration), activity reports (exchanges and conversions), activity reports (rewards and bonuses), reports on rules management, fraud reports (spending), and a feedback mechanism for feeding back pattern data to help refine the processing layer functions.

Another embodiment of the invention enables accessing real world media and or virtual world media from media storage platform (4) previously described above. Another opting may be the ability for the consumer to access a plurality of financial accounts (65) through the UAR (15), wherein access may in various embodiments comprise querying the system, performing data edits, sharing, and transacting, accessing real world media and or virtual world media, etc. In one embodiment, a consumer's query may be accompanied by rule invocation resulting in presentation of advertisements or rewards incentives offered the consumer by third party vendors working the event while the consumer is querying their accounts data.

In this embodiment, a consumer may access their real-world media and or virtual world media via a key-word search, an image search, a report on activity of their GPS location(s), and the like. In an exemplary embodiment, pan-portfolio analysis includes the first database (14) and or the subset database (17) electronically analyzing real world media and or virtual world media provided to the consumer to determine a repeat pattern or frequency for use in predicting probability statistics at the granularity level of the current event or over a number of events attended by the consumer held over a period of time. Analytic processes enable the development of mathematical models and neural networks for rewards programs, micro-merchandising, data mining, and the like. Data that is analyzed may be compiled within the first database or subset database including media held in media storage such as a plurality of real-world media files and virtual world media files.

In one exemplary embodiment, if a consumer wishes to purchase from something comprising a magazine, a wall poster such as tickets to a live music festival performance or the like, the consumer might optically scan the product offering data from the magazine, wall poster, etc. Alternatively, the consumer may input the data. The consumer computing appliance may package the data, symbols, icons, or textual nicknames for consumer financial accounts selected from the store on the consumer appliance. The consumer may forward this information package while connected to the first database that will process the package and transaction(s) by navigating to third-party platforms such as payment processors MasterCard®, Visa®, American Express®, Discover® Financial Services, FDC® (First Data Corporation), TSYS®, or Certegy®). The first database may respond by notification to the consumer appliance when the transaction is complete or if there is a problem.

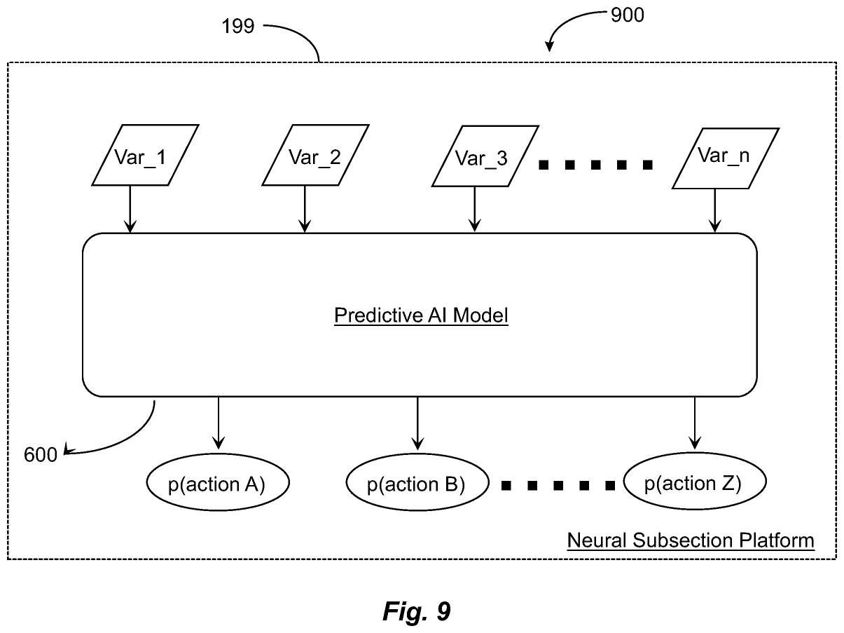

FIG. 9 is a block diagram 900 depicting processing on a neural subsection platform 199. FIG. 9 depicts a predictive model 600 within the neural platform 199 of the first database 14, which provides rules base 50. The model covers predictive purchasing patterns, predictive rewards redemption, predictive real world capture events and virtual world media preferences, predictive advertising impact on the consumer, and the like. Predictive Model 600 has a set of n input variables (Var_1-Var_n) representing a set of n possible actions. Model 600 outputs probability stats p relative to actions A through Z. Probabilities are normalized (sum up to “1”). This normalization may be avoided by constructing individual predictive models to estimate the probability for each individual action a consumer may take. An implicit segmentation is imposed by setting a low threshold for each probability, for example r may be defined as representing the segment of the population for which P(action A) is less than a specified threshold T (sub-A). By scoring the pan-portfolio (or plurality Financial Accounts 65 in the UAR 15) data, the desired segmentation is obtained. The probability to pay given a complex action is computed either by using the predictive model estimate or by using the previously discussed prior probability. The prior probability for a population segment is computed as the probability to pay given all possible actions whose marginal probabilities exceed the corresponding thresholds.

Further to the above, the neural platform 199 may use an intelligent tracking agent that is adapted to extrapolate existing preferences and online activity patterns of a consumer to automatically and periodically recommend to the consumer new data that may expand or delete the consumer's pattern data and execution commands based upon the intelligent algorithmic projection of what the consumer's online preferences and activities will be in the future. In another embodiment, an execution command functioning as an intelligent tracking may extrapolate data patterns relative to the consumer's real-world media capturing, or virtual world media interaction to provide customized recommendations to the consumer on merchandise and vendor services available from any number of Internet web sites or Third-Party Platforms that are in the domain of the vendors and merchants working the event or who may be associated with the event at a broader level. Examples include the Execution Commands for retrieval of new types of music, books, music festivals, and performer merchandise that reflect the consumer's preferences but that such recommendations are previously based on the weight of comparative data.

Other execution commands cover presenting and displaying information to the consumer based on real time scheduling and activities including location. A consumer may see consumer rewards incentives, customized advertising. For example, the consumer may see an ad for ski apparel when the consumer's schedule indicates a ski trip departure, location arrival, or in time reserved before the trip is scheduled. A consumer might see an advertisement for new coffee flavors from the consumer's preferred vendor during the consumer's morning work session. An execution command may be created for displaying information relative to a consumer activity program the consumer connects to using an Internet capable device like a fitness tracking device or an exercise machine or station where presented data may include prior statistics and recommended time and task performance steps or repetitions to enhance or improve the consumer's progress toward a longer-term goal. There are many possible use case scenarios.

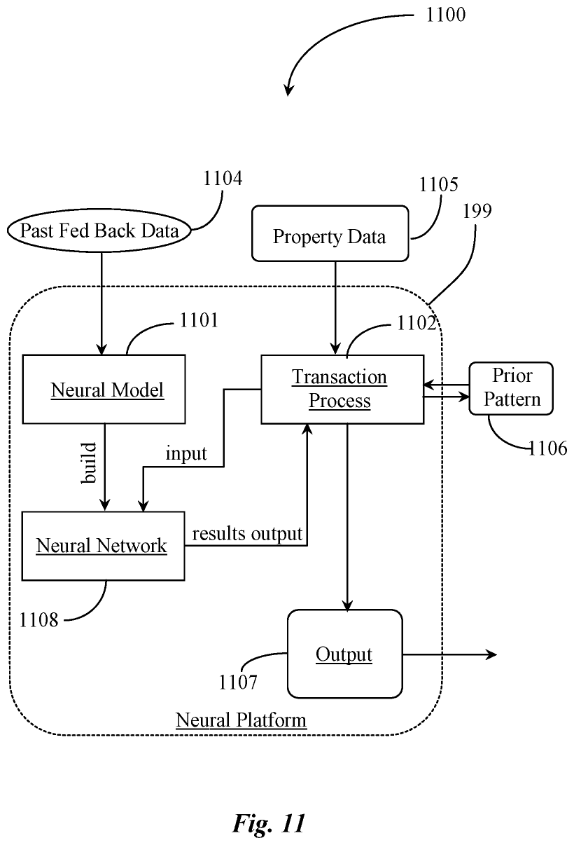

Referring now to FIG. 11, a block diagram 1100 depicts intelligent processing of instant transactions using the AI model 600 of FIG. 9. FIG. 9 illustrates overall functional architecture of the neural platform (NP) 199 of the data platform (first database) 14. Neural platform 199 is broken down into components including a neural model 1101, a neural network 1108, and transaction processing platform 1102.

Neural model 1101 uses past data 1104 to build neural network 1108 containing information representing learned relationships among a number of variables. Together, the learned relationships form a model of the behavior of the variables. Although a neural network is used in the preferred embodiment, any type of predictive modeling technique may be used without departing from the spirit and scope of the invention.

In this implementation, transaction processing platform 1102 performs three functions. A first function may be to make a prediction of profitability of fraud for each transaction made. Data may be fed into the neural network 1108 by feeding input data from various sources. Property data 1105 may be fed into the transaction process 1102 and into the neural network 1108 according to the direction of the arrows.

Prior pattern data 1106 may be fed into transaction process 1102 and into the neural network 1108. Neural network 1108 may process data using rules and may output data results into the transaction process 1102 in near real time resulting in output data 1107 from the transaction process 1102. In one embodiment, transaction process 1102 may create records and output those back into a data base or store containing the prior pattern history of transactions that summarize the past transactional patterns of the consumer. Regular updating occurs with each transaction completed. In this embodiment, one or more consumer preferences may be discovered from pattern data recognized on the neural network. Also, in this embodiment, the pattern data may be derived from one or more of data search patterns of a consumer, advertisement response patterns of a consumer, purchasing patterns of a consumer, account selection patterns of a consumer, value or offer redemption patterns of a consumer, and geographic location patterns of a consumer.

Neural model 1101 may further comprise software (SW) adapted to form learning tasks through repetitive exposure to data such as past data 1104 and adjustment of internal weights that may be provided as constants in rules-based equations. The system promotes rapid model development and automated data analysis. Moreover, neural networks provide at least one statistical modeling technique that is capable of building models from data containing both linear and non-linear relationships.

While similar in concept to regression analysis, neural networks are able to capture nonlinearity and interactions among independent variables without prior specification. More particularly, while traditional regression analysis requires that nonlinear metrics and interactions be detected and specified manually, neural platform 199 performs these tasks automatically. For a more detailed description of neural networks, see D. E. Rumelhart et al, “Learning Representations by Back-Propagating Errors”, Nature v. 323, pp. 533-36 (1986), and R. Hecht-Nielsen, “Theory of the Backpropagation Neural Network”, in Neural Networks for Perception, pp. 65-93 (1992), the teachings of which are incorporated herein by reference.

In augmented reality preparation, a correlation module in the form of a SW program includes an object recognition algorithm to identify virtual objects in the image frame of the consumer's media. For example, the object recognition algorithm may include the scale-invariant feature transform (SIFT) algorithm, the robust features (SURF) algorithm, the oriented FAST (Features from Accelerated Segment Test) and rotated BRIEF (Binary Robust Independent Elementary Features) (ORB) algorithm, the FAST+Fast Retina Key Point (FREAK) algorithm, the Binary Robust Invariant Scalable Keypoints (BRISK), and/or any other object recognition algorithm.

In one embodiment, the correlation module may include a probabilistic model to speed up object recognition on a consumer's operating platform. For example, the probabilistic model may include the Gaussian Mixture Model (GMM) and the Bernoulli Mixture Model (BMM). The probabilistic model may be selected based on the object recognition algorithm. For example, the object recognition algorithm may include BMM built upon ORB (Oriented FAST and Rotated Brief) functions as GMM does not integrate with binary descriptors as found in ORB.

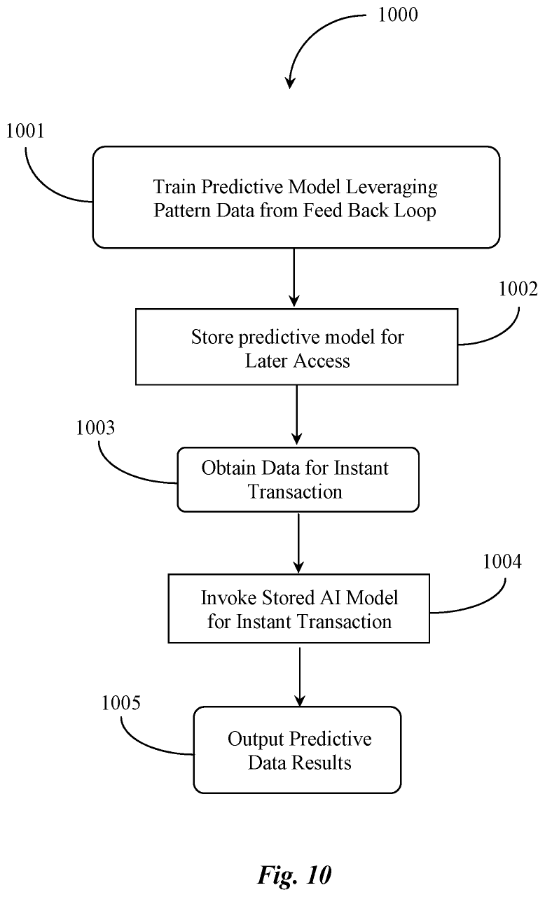

FIG. 10 is a process flow chart depicting steps for training the AI model of FIG. 9. Referring now to FIG. 10, a process flow chart 1000 depicts steps for training the predictive model 600 of FIG. 9. At step 1001, the predictive model is trained using pattern data and new input variables. Training under step 1001 may include (1) Repeatedly inputting samples of a particular input or output task to a neural network model, (2) repeatedly comparing the actual data output from the model to the desired output of the model and quantifying error, and (3) modifying model weighting constants where exposed to reduce error as referenced above in FIG. 9 referencing predictive model 600.

At step 1002, the predictive model maybe stored in data platform 14 for later access during transaction events or activities that rely on the model to make decisions for and send recommendations to a consumer. At step 1003, the first data platform may obtain data relative to an instant transaction in process. An execution command invokes the predictive model during the transaction process offline (POS) or online (Checkout) transaction activity of the consumer.

At step 1004, the predictive model may be invoked and executed for the transaction in progress. At step 1005, the predictive model outputs predictive results relative to the current activity including options available to the consumer. In one embodiment, the predictive model may be used to make recommendations which may pop up as notifications in the meta browser window (51) of the consumer. In one embodiment, the predictive model output data may according to one or more rules in a rules base (50) trigger an executable command (52) to perform a selection, invoke a program, highlight a specific account as a priority account, invoke an account, auto fill dialog boxes or the like.

The predictive model is not required in order to practice the present invention however, it functions to improve and fine tune the consumer's experience and helps to predict, in a general sense, the needs of the consumer moving forward and aids in some instances in advising the consumer or working on behalf of the consumer to accelerate achievement of a financial goal set by the consumer.

In one aspect, an executable command (52) may be adapted to function as an intelligent tracking and extrapolating agent that may process the consumer's real world media data and or virtual world media data from the augmented reality presentation and may identify patterns for making recommendations customized to the consumer's preferences of merchandise, services, or other offers from any number of connected third party platforms. Such recommendations may include pricing and links for direct transacting. For example, a command may include retrieval of new types of music, books, music festivals, and performer merchandise that reflect the consumer's preferences as teased out in recognition of the consumer's patterns of activity.

In another aspect, an execution command (52) integrates consumer data from a calendar and or scheduling program to provide the consumer with customized recommendations on for products, services, or upcoming events based on the consumer's scheduled activities. An action resulting from triggering an executable command may include, initiating a financial transaction, sending a digital message or notification, registering a digital vote, sharing computer displayed content between two or more consumers, sharing pattern data amongst consumers, providing digital access to value offers, making or securing a reservation, providing edit access to pattern data, accessing a website, accessing one or more digital files including media content, invoking a navigation path in a web browser or meta browser and sharing Geo-location data of a consumer with one or more other consumers or third parties.

FIG. 11 is a block diagram 1100 depicting intelligent processing of instant transactions using the AI model 600 of FIG. 9. Neural platform 199 is broken down into components including a neural model 1101, a neural network 1108, and transaction processing platform 1102.

Neural model 1101 uses past data 1104 to build neural network 1108 containing information representing learned relationships among a number of variables. Together, the learned relationships form a model of the behavior of the variables. Although a neural network is used in the preferred embodiment, any type of predictive modeling technique may be used without departing from the spirit and scope of the invention.

In this implementation, transaction processing platform 1102 performs three functions. A first function may be to make a prediction of profitability of fraud for each transaction made. Data may be fed into the neural network 1108 by feeding input data from various sources. Property data 1105 may be fed into the transaction process 1102 and into the neural network 1108 according to the direction of the arrows.

Prior pattern data 1106 may be fed into transaction process 1102 and into the neural network 1108. Neural network 1108 may process data using rules and may output data results into the transaction process 1102 in near real time resulting in output data 1107 from the transaction process 1102. In one embodiment, transaction process 1102 may create records and output those back into a data base or store containing the prior pattern history of transactions that summarize the past transactional patterns of the consumer. Regular updating occurs with each transaction completed.

Neural model 1101 may further comprise software (SW) adapted to form learning tasks through repetitive exposure to data such as past data 1104 and adjustment of internal weights that may be provided as constants in rules-based equations. The system promotes rapid model development and automated data analysis. Moreover, neural networks provide at least one statistical modeling technique that is capable of building models from data containing both linear and non-linear relationships.

While similar in concept to regression analysis, neural networks are able to capture nonlinearity and interactions among independent variables without prior specification. More particularly, while traditional regression analysis requires that nonlinear metrics and interactions be detected and specified manually, neural platform 199 performs these tasks automatically. For a more detailed description of neural networks, see D. E. Rumelhart et al, “Learning Representations by Back-Propagating Errors”, Nature v. 323, pp. 533-36 (1986), and R. Hecht-Nielsen, “Theory of the Back propagation Neural Network”, in Neural Networks for Perception, pp. 65-93 (1992), the teachings of which are incorporated herein by reference.

It may be appreciated by one with skills in the art that an augmented reality controller may operate on the first database and on a sub database that computationally processes real world media received from a consumer's computing appliance in order to identify and match real world objects identified in the content within the image and or video frames with the associated pattern data content and associated executable commands such that this data can be retrieved and provided for consumption on the consumer's appliance in the field. The virtual world meta data may further include a QR code, a two-dimensional image, a three-dimensional image, text, an audio file, a video file, a link to a website, an interactive annotation, and or any other visual or audible data that may be augmented to the real-world media being rendered on a consumer's computing appliance.

In certain embodiments, a master verification platform may be provided to verify consumers and third parties associated with advertising or providing information about the event and future events. It may log the entire set of passwords digital signatures, digital certificates and the like registered for access and use of the system whether a consumer or third-party vendor. The front-end database structure may appear similar to both the consumer and third party allowing them to switch roles seamlessly.

In one aspect, first data platform 14 is charged with storage of pattern data (54) including real world media and virtual world media, executable commands (52), and rules in rules base (50) registered to consumers and third parties authorized to use the system. In one aspect, master user account registry may be charged with storage of all of real-world media captured and virtual world media submitted or sponsored, and all financial accounts (65) of the consumer, and like data relative to third party platforms that are dedicated vendors and those who provide services and those who also are consumers.

It will be apparent with skill in the art that the augmented reality advertising system and methods of the present invention may be provided using some or all the elements described herein. The arrangement of elements and functionality thereof relative to the smart card of the invention is described in different embodiments each of which is an implementation of the present invention. While the uses and methods are described in enabling detail herein, it is to be noted that many alterations could be made in the details of the construction and the arrangement of the elements without departing from the spirit and scope of this invention. The present invention is limited only by the breadth of the claims below.

1. An advertising network comprising:
a first server connected to the network, the first server coupled to at least one data repository containing real world media belonging to individual ones of consumers that recorded or are recording the media at a live event;
a second server connected to the network, the second server coupled to at least one data repository containing sample media and virtual world media and supporting meta data belonging to individual ones of third-party vendors, merchants, or service providers the sample media previously recorded at the event location;
a server interface to the first server distributed over the network to individual ones of computing appliances connected to the network as end nodes, the computing appliances operated by the consumers; and
a non-transitory medium resident on the first server, the non-transitory medium containing machine-readable code thereon, the code executable and instructing the first server to;
(a) process the real-world media captured by the consumer against sample media previously recorded by the third-party vendor, merchant, or service provider to identify virtual objects associated with virtual world media and supporting meta data by the vendors, merchants, and service providers;
(b) upon recognizing one or more virtual objects designated by the third-party vendors, merchants, or service providers in the consumer's real-world media, retrieving associated virtual world media and supporting meta data;
(c) integrating the retrieved virtual world media and supporting meta data with the real-world media of the consumer in the form of an augmented reality overlay layer; and
(d) transmitting the augmented media to a computing appliance operated by the consumer for display on the consumer's computing appliance.

2. The advertising network of claim 1, wherein the network is the Internet network and any connected sub networks, and the real-world media includes one or more images, videos, or audible recordings.

3. The advertising network of claim 2, wherein the virtual world media includes one or more interactive images, icons, videos, pop-up windows, or an audible recording and supporting meta data includes, interactive text, graphics, navigable web links, and executable widgets.

4. The advertising network of claim 1, wherein network connectivity between the first server and consumer computing appliances is through one of a third generation (3G), fourth generation (4G), or fifth generation (5G) wireless network, a satellite communication network, a microwave radio network, local area network (LAN), a wireless fidelity (WiFi) network, or a wide area network (WAN).

5. The advertising network of claim 4, wherein the computing appliance is one of a lap top computer, a personal digital assistant (PDA), a cellular phone, a smart phone, a smart watch, or another smart wearable device.

6. The advertising network of claim 1, wherein the stored real-world media and the stored virtual world media may be data mined for patterns wherein the pattern data may be incorporated into a rule associated with an executable command that may be automatically triggered or manually triggered.

7. The advertising network of claim 6, wherein an action resulting from triggering an executable command may include, initiating a financial transaction, sending a digital message or notification, registering a digital vote, sharing computer displayed content between two or more consumers, sharing pattern data amongst consumers, providing digital access to value offers, making or securing a reservation, providing edit access to pattern data, accessing a website, accessing one or more digital files including media content, invoking a navigation path in a web browser extension or a meta browser extension and sharing Geo-location data of a consumer with one or more other consumers or third parties.

8. The advertising network of claim 1, further including a function (e) for a processor processing augmentation to real world media to access a neural platform and retrieve one or more consumer preferences relating to stored real-world media and associated virtual world media and any supporting meta data.

9. The advertising network of claim 8, wherein the one or more consumer preferences are discovered from pattern data recognized on the neural network.

10. The advertising network of claim 9, wherein the pattern data includes one or more of data search patterns of a consumer, advertisement response patterns of a consumer, purchasing patterns of a consumer, account selection patterns of a consumer, value or offer redemption patterns of a consumer, and geographic location patterns of a consumer.

11. The advertising network of claim 7, wherein the web browser extension or the meta browser extension is a computer program using an application programming interface from the first database to integrate with existing web browsers including but not limited to Google Chrome, Opera, Microsoft Explorer, Apple Safari, and Mozilla Firefox.

12. The advertising network of claim 1, wherein virtual objects are recorded by third party vendors, merchants or service providers and are associated with virtual world media and associated meta data.

13. The advertising network of claim 1, wherein consumers and third-party vendors, merchants, and service providers subscribe to a service to enable practice on the advertisement network.

14. The advertising network of claim 13, wherein third-party vendors, merchants, and service providers pay for virtual objects as advertising space.

15. The advertising network of claim 1, wherein the first and second servers share a media storage platform repository for storing real world media and virtual world media and supporting meta data instead of maintaining separate media repositories.
